(19) United States
(12) Patent Application Publication
(10) Pub. No.: US 2018/0364000 A1
(43) Pub. Date: Dec. 20, 2018

(54) Firearm Tracking System

(71) Applicant: Garland Sims, Jackson, LA (US)

(72) Inventor: Garland Sims, Jackson, LA (US)

(21) Appl. No.: 16/007,164

(22) Filed: Jun. 13, 2018

Related U.S. Application Data
(60) Provisional application No. 62/521,662, filed on Jun. 19, 2017.

(51) Int. Cl. F41A 17/06; F42B 12/38; G01S 19/14

(52) U.S. Cl. CPC F41A 17/063; G01S 19/14; F42B 12/382

(57) ABSTRACT

A firearm tracking system to locate missing firearms. The firearm tracking system includes a firearm, having a body with a chamber designed to hold a plurality of bullets, a barrel designed to fire each bullet, and a trigger in communication with the chamber and barrel. A GPS unit is removably secured within the body of the firearm, and the GPS unit is in constant communication with a mobile electronic device designed to detect the location of the firearm. The trigger is designed to lock when the GPS unit is not secured within the body of the firearm. A power source is additionally disposed within the firearm and designed to provide power to the GPS unit and a solar panel, operably connected to the power source, is located on the firearm. In this way, the firearm tracking system is designed to provide a constant and accurate location of a missing firearm.

### CROSS REFERENCE TO RELATED APPLICATION

This application claims the benefit of U.S. Provisional Application No. 62/521,662 filed on Jun. 19, 2017. The above identified patent application is herein incorporated by reference in its entirety to provide continuity of disclosure.

### BACKGROUND OF THE INVENTION

The present invention relates to firearm tracking systems. More specifically, the present invention provides a firearm, having a GPS unit removably secured within the body with a power source additionally disposed within the firearm to power the GPS unit, as well as a solar panel disposed on the firearm and operably connected to the power source. The GPS unit is in constant communication with a mobile electronic device configured to detect the location of the firearm.

Police or other owners of firearms will lose their guns or have them stolen by an individual. Unfortunately, when these firearms are lost it is difficult to find them and many are never recovered. These stolen firearms are dangerous and can be used to commit multiple crimes. Often, these are crimes that would otherwise have been avoided if the owner been able to locate the firearm quickly. Similarly, police often want to track the location of the bullets fired from their gun, as these can provide important evidence for the police, however, bullets can be difficult to find once fired.

In light of the devices disclosed in the known art, it is submitted that the present invention substantially diverges in design elements from the known art and consequently it is clear that there is a need in the art for an improvement to existing firearm tracking systems. In this regard the instant invention substantially fulfills these needs.

### SUMMARY OF THE INVENTION

In view of the foregoing disadvantages inherent in the known types of firearm tracking systems now present in the known art, the present invention provides a new firearm tracking system wherein the same can be utilized for providing convenience for the user when trying to locate their lost or missing firearm.

It is therefore an object of the present invention to provide a new and improved firearm tracking system that has all of the advantages of the known art and none of the disadvantages. The improved firearm tracking system comprises a firearm, having a body comprising a chamber configured to house a plurality of bullets, a barrel configured to fire each bullet, and a trigger in communication with the chamber and barrel such that actuating the trigger fires a bullet through the barrel. A GPS unit is removably secured within the body of the firearm, wherein the GPS unit is in constant communication with a mobile electronic device configured to detect the location of the firearm. The trigger is configured to lock when the GPS unit is not secured within the body of the firearm. A power source is additionally disposed within the firearm and configured to provide power to the GPS unit. A solar panel is disposed on the surface of the firearm and operably connected to the power source.

It is another object of the invention to provide a plurality of tagged bullets configured to load into the chamber of the firearm and fire from the barrel of the firearm, wherein each tagged bullet further comprises a miniaturized tracking device in communication with the GPS unit such that each tracking bullet can be located once fired. In one embodiment, the miniaturized tracking device comprises an RFID tag. In another embodiment, the solar panel is disposed on an upper side of the barrel. In a further embodiment, the power source comprises a rechargeable battery.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the firearm tracking system.

FIG. 2 shows a perspective view of an embodiment of the firearm tracking system.

FIG. 3 shows a perspective view of an embodiment of the tagged bullets.

FIG. 4 shows a schematic of an embodiment of the control system within the firearm.

### DETAILED DESCRIPTION OF THE INVENTION

Reference is made herein to the attached drawings. Like reference numerals are used throughout the drawings to depict like or similar elements of the firearm tracking system. The figures are intended for representative purposes only and should not be considered to be limiting in any respect.

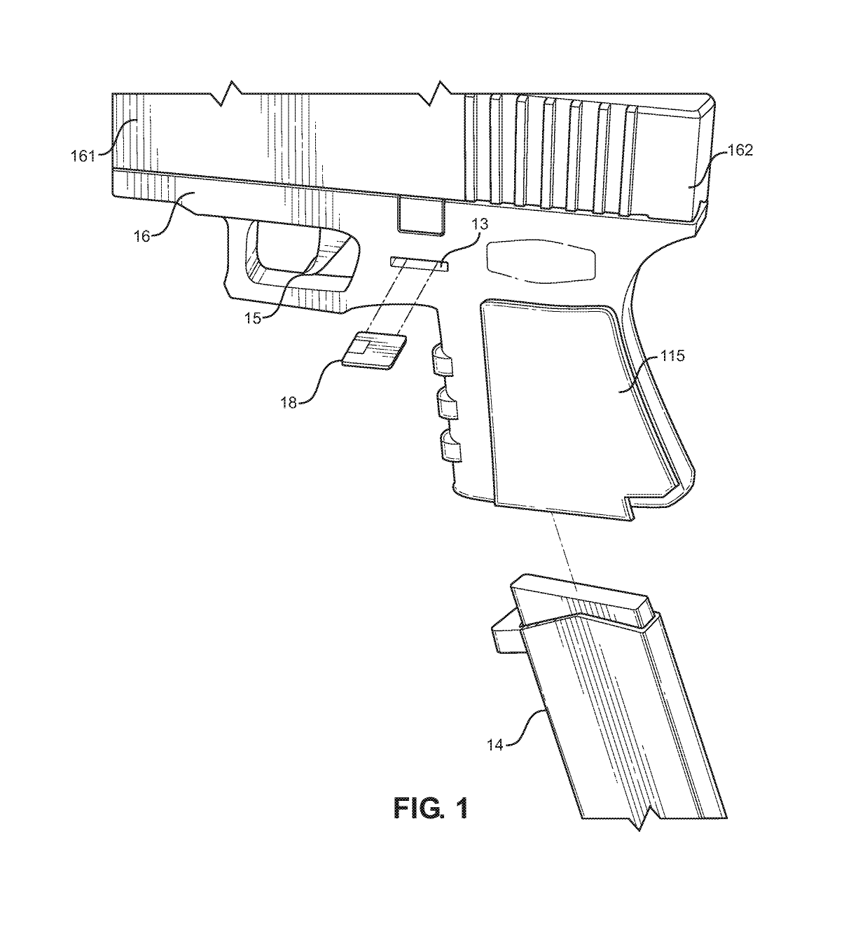

Referring now to FIG. 1, there is shown an exploded view of an embodiment of the firearm tracking system. A firearm tracking system 11 comprises a firearm which is configured to act in a manner similar to a traditional firearm. In the illustrated embodiment, the firearm is a type of pistol, however in other embodiments the firearm is a type of rifle. The firearm has a handgrip 115 comprising a chamber within, wherein the chamber is configured to receive a clip 14 housing a plurality of bullet cartridges therein. The firearm further comprises a barrel 16, having a first end 161 and a second end 162. The second end 162 of the barrel 16 is configured to accept a bullet cartridge from the chamber such that it is loaded within the barrel 16, and fire a bullet from the first end 161. A trigger 15 is secured beneath the barrel 16 and proximal to the handgrip 115, wherein the trigger 15 is in communication with the chamber and barrel 16, such that actuating the trigger 15 fires one bullet from the plurality of bullet cartridges therein through the barrel 16.

A GPS unit 18 is removably secured within an aperture 13 of the firearm. In the shown embodiment, the aperture 13 is disposed on a side of handgrip 115, however in other embodiments, the aperture 13 is disposed elsewhere on the firearm, such that the GPS unit 18 cannot be dislodged when a bullet is fired. In the shown embodiment, the aperture 13 is disposed as a slot, such that when the GPS unit 18 is slidably secured within the firearm, the GPS unit is disposed perpendicular to the barrel 16. However, in other embodiments, the aperture 13 is sized such that the GPS unit 18 can slidably secure within the aperture 13, such that the GPS unit 18 is disposed parallel to the barrel 16. The GPS unit 18 is in constant communication with a mobile electronic device, such that the GPS unit 18 is configured to continuously monitor the location of the firearm and report the location to the mobile electronic device, such as a cell phone or a computer.

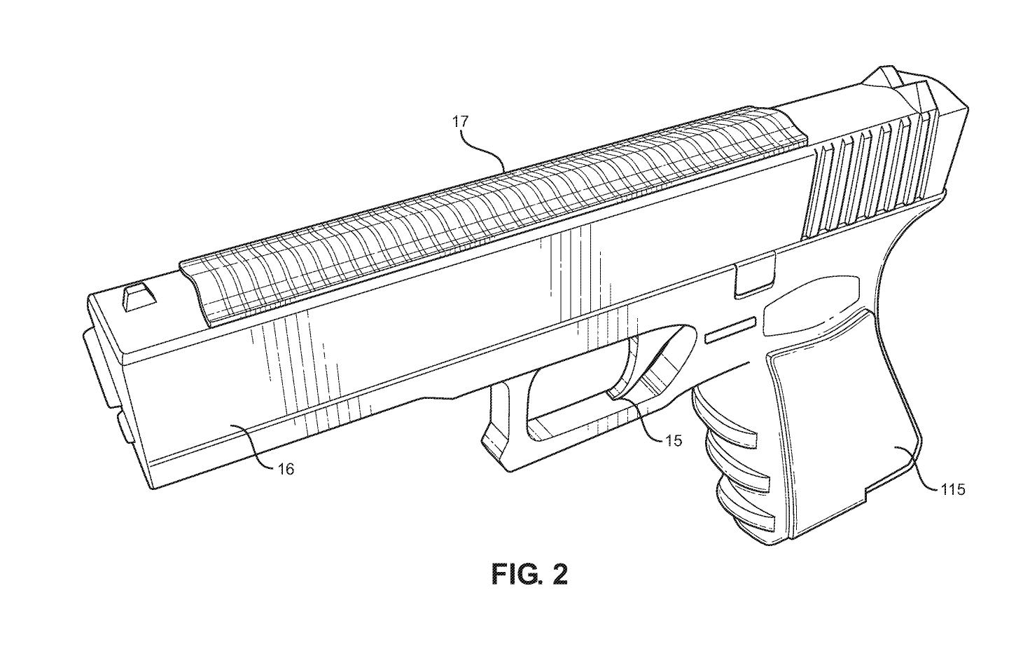

Referring now to FIG. 2, there is shown a perspective view of an embodiment of the firearm tracking system. The firearm tracking system further comprises a solar panel 17 configured to charge a power source disposed within the firearm to provide power to the GPS unit 18. In the shown embodiment, the solar panel 17 is disposed on the upper side of the barrel 16. In this way, the solar panel 17 can recharge while the firearm is being held. In one embodiment, the solar panel 17 is elongated, such that it covers at least 75% of the uppermost surface of the barrel 16, however in other embodiments the solar panel 17 comprises a smaller portion of the uppermost surface of the barrel 16. In another embodiment, the solar panel 17 is disposed on a side of the barrel 16 and a side of the body 14, such that the solar panel 17 can recharge while the firearm is disposed on its side wherein the solar panel 17 is in view of the sun. In an additional embodiment the solar panel 17 is disposed on both sides of the barrel 16 and body 14, as well as the top of the barrel 16, such that the solar panel 17 can be charged in any position.

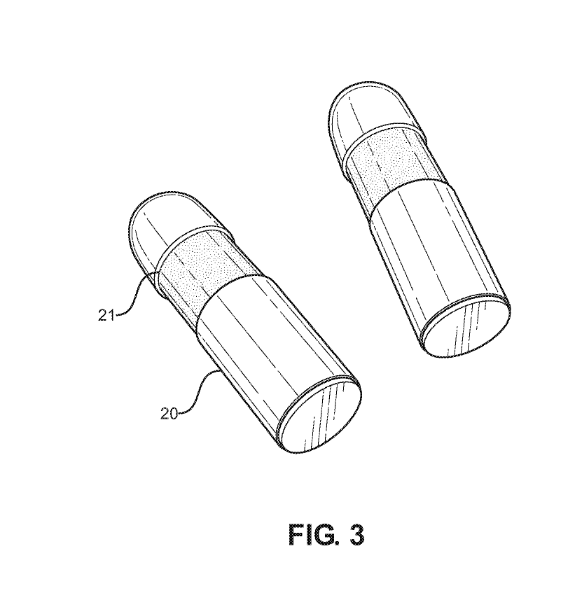

Referring now to FIG. 3, there is shown a perspective view of an embodiment of the tagged bullets. In one embodiment, the firearm tracking system further comprises a plurality of tagged bullets 20 configured to load into the chamber of the firearm and fire from the barrel of the firearm. Each tagged bullet 20 comprises a miniaturized tracking system 21 configured to communicate with the GPS unit such that the GPS unit tracks the location of each tagged bullet 20. The user interface on the mobile electronic device is configured to additionally interface with each tagged bullet 20, such that the user can view the location of each tagged bullet 20 through the user interface. Further, the user interface is configured to determine the total number of tagged bullets 20 initially loaded into the chamber of the firearm, the number of tagged bullets 20 that remain in the chamber, and the number of tagged bullets 20 that were fired. In the shown embodiment, the miniaturized tracking system 21 comprises an RFID tag configured to communicate with the GPS unit. The firearm is configured to accept traditional bullets as well as tagged bullets, however when traditional bullets are used the GPS unit is configured to exclusively track the location of the firearm and not the location of the traditional bullets or total number of traditional bullets left in the chamber.

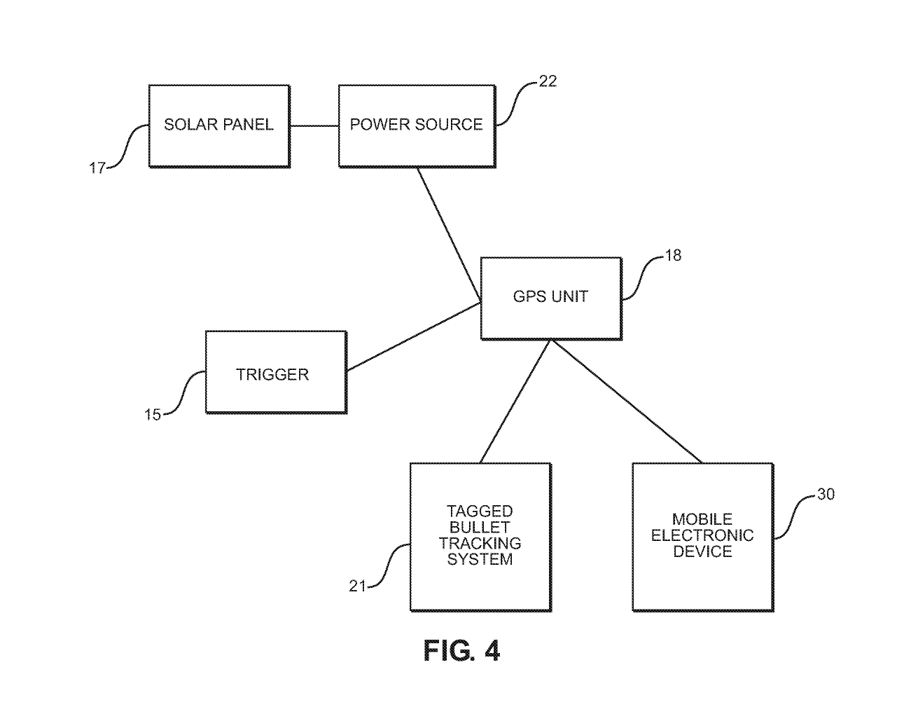

Referring now to FIG. 4, there is shown a schematic of an embodiment of the control system within the firearm. The solar panel 17 is configured to be in communication with a power source 22. The power source 22 is configured to provide power to the GPS unit 18, which is in communication with the trigger 15 the tagged bullet system 21, and the mobile electronic device 30. A user interface is provided within the mobile electronic device 30, which is configured to present a map or other location indicator adapted to display the location of the firearm. In this way, a user who has lost the firearm or who has had the firearm stolen is able to track the location of the firearm and pinpoint the missing firearm. When the tagged bullet cartridges are utilized with the firearm tracking system, such that the tagged bullet tracking system 21 is in communication with the GPS unit 18, the user interface of the mobile electronic device 30 is configured to also display the location of each tagged bullet. The GPS unit 18 is configured to communicate to the mobile electronic device 30 via wireless communication, such as through Bluetooth.

The trigger 15 is additionally configured to be in constant wireless communication with the GPS unit 18 through a receiver. The trigger 15 is configured to lock, such that it is unable to actuate, if the GPS unit 18 is no longer in communication with the trigger 15, similar the safety on the firearm remaining on. In this way, when the GPS unit 18 is not secured within the aperture 13, the trigger 15 will no longer function, thereby preventing a user from utilizing the firearm to fire a bullet, tagged or otherwise.

In operation, a manufacturer will produce a traditional firearm configured to fire the requisite traditional bullets of the firearm and will additionally include a removable GPS unit within the firearm. The user, once purchasing the firearm tracking system, will download the interface application onto their electronic device, such as a cell phone, and configure the GPS unit to track the firearm. In an additional embodiment, the user can also purchase tagged bullets, configured to interface with the GPS unit and interface application. In this way, the user can continually monitor and track the location of their firearm, and in one embodiment the tagged bullets as well.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A firearm tracking system, comprising:
a firearm, having a body comprising a chamber configured to house a plurality of bullets, a barrel configured to fire each bullet, a trigger in communication with the chamber such that actuating the trigger fires a bullet through the barrel;
a GPS unit removably secured within the body of the firearm, wherein the GPS unit is in constant communication with a mobile electronic device configured to continuously monitor the location of the firearm;
a power source configured to power GPS unit;
a solar panel disposed on the surface of the firearm operably connected to the power source;
wherein the trigger s configured to lock when the GPS unit is not secured within the body of the firearm.

2) The firearm tracking system of claim 1, further comprising:
a plurality of tagged bullets configured to load into the chamber of the firearm and fire from the barrel of the firearm;
wherein each tagged bullet comprises a miniaturized tracking device in communication with the GPS unit, such that each tracking bullet can be located once fired.

3) The firearm tracking system of claim 2, wherein the miniaturized tracking device comprises a RFID tag.

4) The firearm tracking system of claim 1, wherein the solar panel is disposed on an uppermost side of the barrel.

5) The firearm tracking system of claim 4, wherein the solar panel is elongated, such that the solar panel comprises at least 75% of the uppermost side of the barrel.
